(19) United States
(12) Patent Application Publication
(10) Pub. No.: US 2023/0001687 A1
(43) Pub. Date: Jan. 5, 2023

(54) JIGS FOR USE WHEN SUBLIMATION PRINTING ON SOCKS, SUBLIMATION PRINTABLE SOCKS WITH PREINSTALLED JIGS, AND RELATED SYSTEMS AND METHODS

(71) Applicant: Wee Ones, LLC, Earth City, MO (US)

(72) Inventors: Miles P. FAUST, Kirkwood, MO (US); Allison Faust KARL, Ballwin, MO (US)

(21) Appl. No.: 17/746,267

(22) Filed: May 17, 2022

Related U.S. Application Data
(60) Provisional application No. 63/217,807, filed on Jul. 2, 2021.
(60) Provisional application No. 63/216,606, filed on Jun. 30, 2021.

(30) Foreign Application Priority Data
Aug. 30, 2021 (CN) 202122067423.3
Feb. 18, 2022 (CN) 202220340280.0

(51) Int. Cl. B41F 17/38; B41M 5/382

(52) U.S. Cl. CPC B41F 17/38; B41M 5/382

(57) ABSTRACT

Exemplary embodiments are disclosed of jigs (broadly, inserts) for use when sublimation printing on socks, production ready sublimation printable socks with preinstalled jigs therein, and related systems and methods. In an exemplary embodiment, a jig includes an upper portion and a lower portion. A first transition or rounded shoulder portion is along a first side of the jig between the upper portion and the lower portion. A second transition or rounded shoulder portion is along a second side of the jig between the upper portion and the lower portion.

### CROSS-REFERENCE TO RELATED APPLICATIONS

This application is a U.S. Non-Provisional patent application that claims the benefit and priority of U.S. Provisional Application No. 63/216,606 filed Jun. 30, 2021 and U.S. Provisional Application No. 63/217,807 filed Jul. 2, 2021.

This application also claims the benefit and priority of Chinese utility model patent application No. 202122067423.3 filed Aug. 30, 2021 (now granted Chinese utility model patent ZL202122067423.3 issued May 13, 2022), and Chinese divisional utility model application No. 202220340280.0 filed Feb. 18, 2022.

The entire disclosures of the above applications are incorporated herein by reference.

### FIELD

The present disclosure relates to jigs (broadly, inserts) for use when sublimation printing on socks, production ready sublimation printable socks with preinstalled jigs therein, and related systems and methods.

### BACKGROUND

This section provides background information related to the present disclosure which is not necessarily prior art.

Sublimation printing is a process that may be used to transfer a design into fabric using ink and heat. For example, sublimation printing may be used to transfer a design to a sock.

### DRAWINGS

The drawings described herein are for illustrative purposes only of selected embodiments and not all possible implementations and are not intended to limit the scope of the present disclosure.

FIG. 1 illustrates socks including jigs (broadly, inserts) therein configured (e.g., shaped with rounded shoulder portions or transitions, etc.) to allow the jigs to be slidably removed from the socks seamlessly without the jigs snagging the socks after sublimating printing on the socks according to exemplary embodiments of the present disclosure.

FIG. 2 illustrates the jigs shown in FIG. 1 with exemplary dimensions in centimeters for purpose of illustration only.

FIG. 3A illustrates the toddler ankle sock and jig shown in FIG. 1.

FIG. 3B illustrates the jig shown in FIG. 3A with exemplary dimensions in centimeters for purpose of illustration only.

FIG. 4A illustrates the no-show sock and jig shown in FIG. 1.

FIG. 4B illustrates the jig shown in FIG. 4A with exemplary dimensions in centimeters for purpose of illustration only.

FIG. 5A illustrates the kids crew sock and jig shown in FIG. 1.

FIG. 5B illustrates the jig shown in FIG. 5A with exemplary dimensions in centimeters for purpose of illustration only.

FIG. 6A illustrates the crew sock and jig shown in FIG. 1.

FIG. 6B illustrates the jig shown in FIG. 6A with exemplary dimensions in centimeters for purpose of illustration only.

FIG. 7A illustrates the knee high sock and jig shown in FIG. 1.

FIG. 7B illustrates the jig shown in FIG. 7A with exemplary dimensions in centimeters for purpose of illustration only.

FIG. 8 shows socks including jigs (broadly, inserts) therein configured (e.g., shaped with rounded shoulder portions or transitions, etc.) to allow the jigs to be slidably removed from the socks seamlessly without the jigs snagging the socks after sublimating printing on the socks according to exemplary embodiments of the present disclosure. As shown in FIG. 8, the jigs are configured to allow the socks with the preinstalled jigs therein to be flat, e.g., packed and shipped while flat, etc.

FIG. 9 shows an upper portion of a jig (broadly, an insert) configured (e.g., shaped with rounded shoulder portions or transitions, etc.) to maintain the sock shape to stay intact during sublimation printing and to allow the jig to be slidably removed from a sock seamlessly without the jig snagging the sock according to an exemplary embodiment of the present disclosure.

FIG. 10 shows an upper portion of a conventional jig having sharp angled shoulder portions for holding a sock's cuff in place, which sharp angles may cause the jig to snag, grab the inside of a sock, and pull threads out of place when the jig is being slidably removed from the sock.

FIG. 11 shows an example sock that was sublimation printed while a 0.4 millimeter thick jig was within the sock according to an exemplary embodiment of the present disclosure. As shown in FIG. 11, the sublimation printed sock does not include a visible seam defined by the absence of sublimated ink along a side of the sock.

FIG. 12 shows an example sock that was sublimation printed while a conventional 2 millimeter thick jig was within the sock. As shown in FIG. 12, the sublimation printed sock includes a visible harsh or thick seam along a side of the sock where the sublimated ink did not transfer.

Corresponding reference numerals may indicate corresponding (though not necessarily identical) features throughout the several views of the drawings.

### DETAILED DESCRIPTION

Example embodiments will now be described more fully with reference to the accompanying drawings.

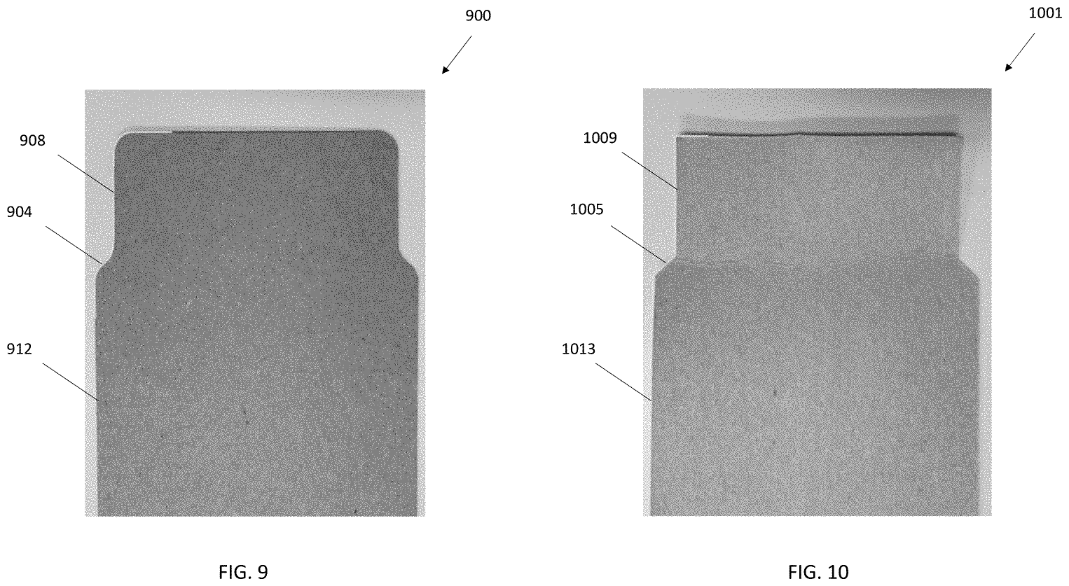

Sublimation printing is a process that may be used to transfer a design to a sock. A jig may be inserted within the sock to hold the sock cuff in place during the sublimation printing process. But as recognized by the inventors hereof, the very sharp angles and/or right angles of conventional jigs that are used for holding a sock's cuff in place will snag and grab the insides of the sock pulling threads out of place when the conventional jig is removed from the sock. See, for example, FIG. 10 that shows a jig 1001 having sharp angled shoulder portions or transitions 1005 between the jig's upper portion 1009 and lower portion 1013. The sharp angles may cause the jig 1001 to snag, grab the inside of a sock, and pull threads out of place when the jig 1001 is being slidably removed from the sock. By comparison, FIG. 9 shows an exemplary embodiment of a jig 900 including rounded shoulder portions or transitions 904 between the jig's upper portion 908 and lower portion 912. As shown in FIG. 9, a generally S-shaped curve is defined along each side of the jig 900 between the jig's upper portion 908 rounded shoulder portion or transition 904, and lower portion 912. Changing the sharp angled portion 1005 of the conventional jig 1001 to generally rounded gradual transitions 904 allows the jig 900 to be slidably removed from a sock seamlessly without the jig 900 snagging the sock, e.g., after the jig 900 has been used to maintain the sock in a generally flat shape during production (e.g., during sublimation printing, etc.), etc.

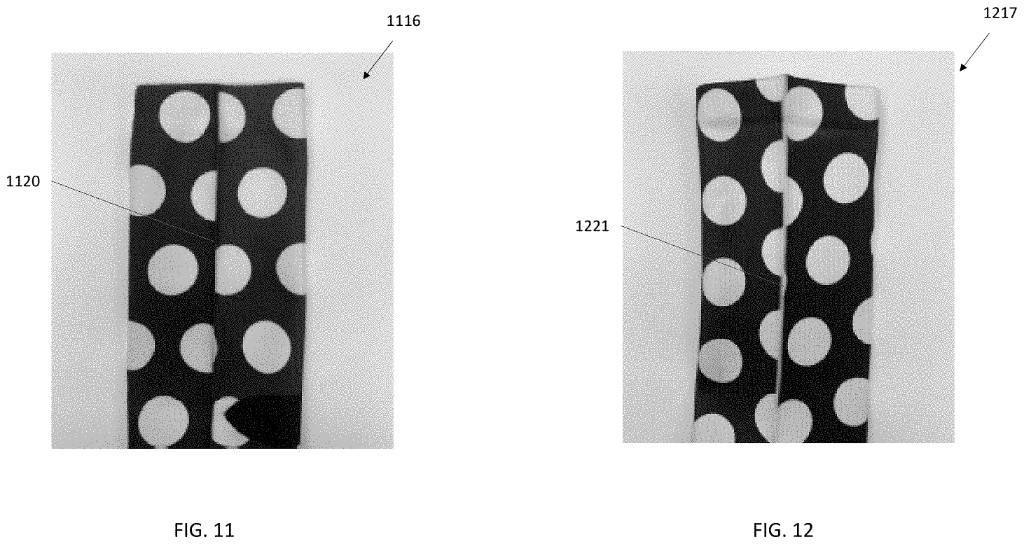

In addition, the inventor(s) hereof have also recognized that conventional jigs tend to be very thick (e.g., thicknesses of 2 millimeters or more, etc.), which thickness results in a harsh or thick white seam (or a non-white seam in the case of a non-white sock). The seam corresponds with the location along which the sublimated ink did not transfer and is visible along the side of the sublimation printed sock. The seam is defined by the absence of sublimated ink along the side of the sock. See, for example, FIG. 12 that shows an example sock 1217 that was sublimation printed while a conventional 2 millimeter thick jig was within the sock. As shown in FIG. 12, the sublimation printed sock 1217 includes a visible harsh or thick seam 1221 defined by the absence of sublimated ink along a side of the sock 1217. By comparison, FIG. 11 shows an example sock 1116 that was sublimation printed while a 0.4 millimeter thick jig was within the sock 1116 according to an exemplary embodiment of the present disclosure. As shown in FIG. 11, the sublimation printed sock 1116 does not include a visible seam 1120 defined by the absence of sublimated ink along a side of the sock 1116.

After recognizing the above drawbacks associated with conventional jigs, the inventor(s) hereof developed and/or disclose herein exemplary embodiments of jigs or insert cards (broadly, inserts) for use when sublimation printing on socks, production ready sublimation printable socks with preinstalled jigs therein, and related systems and methods.

As disclosed herein, exemplary embodiments include a jig or insert card (broadly, an insert) configured (e.g., sized, shaped, etc.) to hold a sock cuff (broadly, an upper portion of a sock) in place during a sublimation printing process. The jig is also configured (e.g., sized, shaped with rounded shoulder portions or transitions, etc.) to allow the jig to be slidably removed from within the sock seamlessly without snagging or grabbing the insides of the sock and pulling threads out of place.

In exemplary embodiments, the jig is configured to have a relatively small thickness (e.g., a thickness less than 2 millimeters, a thickness of 0.4 millimeters, etc.) such that there will be substantially no visible seam where the sublimated ink did not transfer along the side of the sublimation printed sock. For example, an exemplary embodiment of a jig may have a thickness of about 0.4 millimeter, which allows the sublimated ink to substantially entirely cover the seam/edge between the top and bottom sides of a sock, as shown in FIG. 9.

In exemplary embodiments, the jig is configured for use as a disposable single-use jig. The disposable single-use jig may be made of chipboard or other sufficiently inexpensive and/or biodegradable material(s) to thereby be disposable, etc. As recognized by the inventor(s) hereof, using a jig for only a single sublimation printing process advantageously avoids the problem associated with reusing a jig for multiple sublimation printing processes. With a reusable jig, some ink may transfer to the jig during a first sublimation printing process of a first sock. If the same jig is then reused, the transferred ink on the reused jig may then subsequently transfer to the inside of another (e.g., second, third, etc.) sock during a subsequent (e.g., second, third, etc.) sublimation printing process.

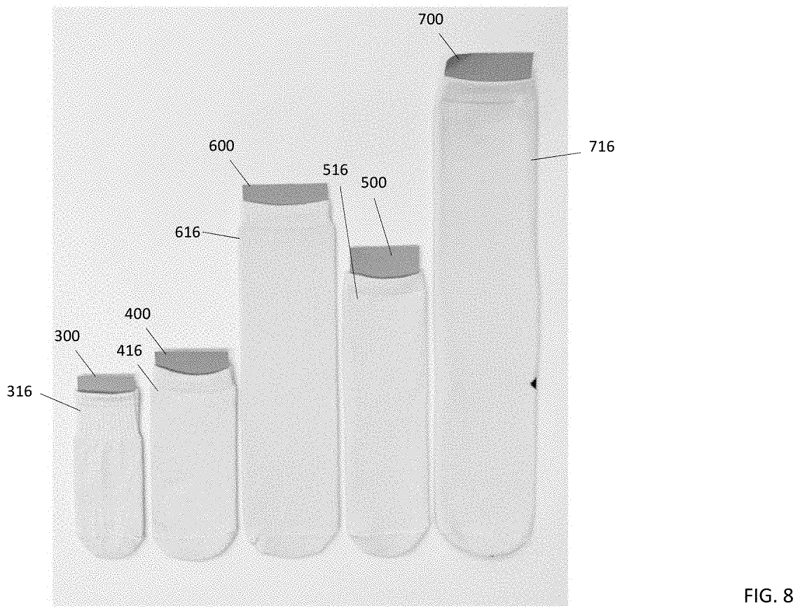

In exemplary embodiments, the jig is configured to be preinstalled within a sock such that the sock with the preinstalled jig therein is production ready for sublimation printing. In exemplary embodiments, the jig is configured to allow the sock with the preinstalled jig therein to be flat, e.g., packed and shipped in a flat stackable configuration in a container, box, large envelope, etc. See, for example, FIG. 8 showing socks 316, 416, 516, 616, 716 with preinstalled jigs 300, 400, 500, 600, 700 therein.

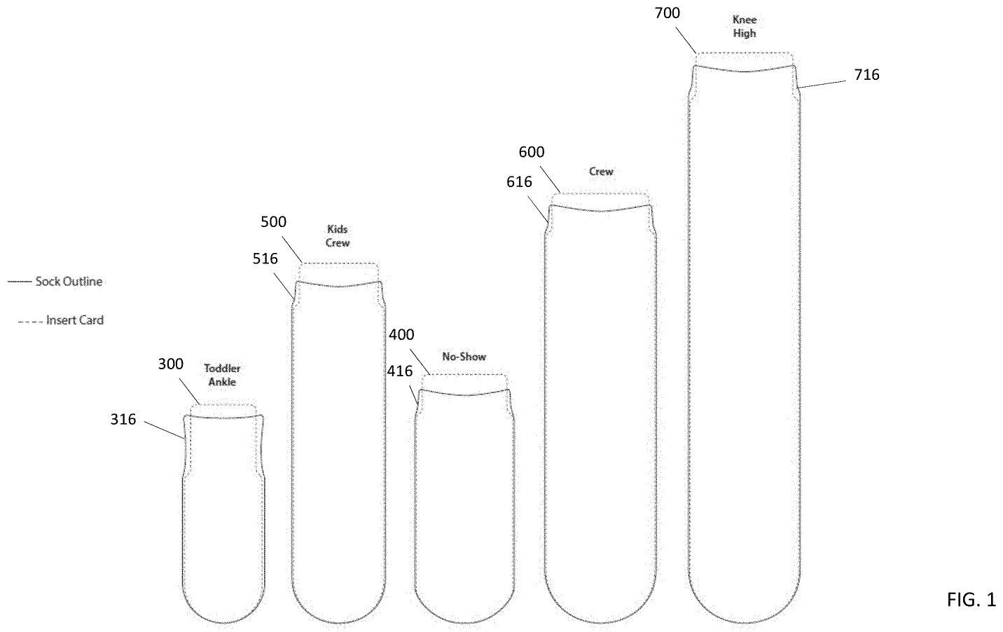

In exemplary embodiments, a length of the jig is greater than an overall length of the sock (e.g., FIG. 1, etc.) such that an upper portion of the jig protrudes outwardly beyond the opening at the top of the sock to thereby provide an exposed upper portion (e.g., pull tab, etc.) of the jig to facilitate grasping and/or slidably pulling the jig from within the sock.

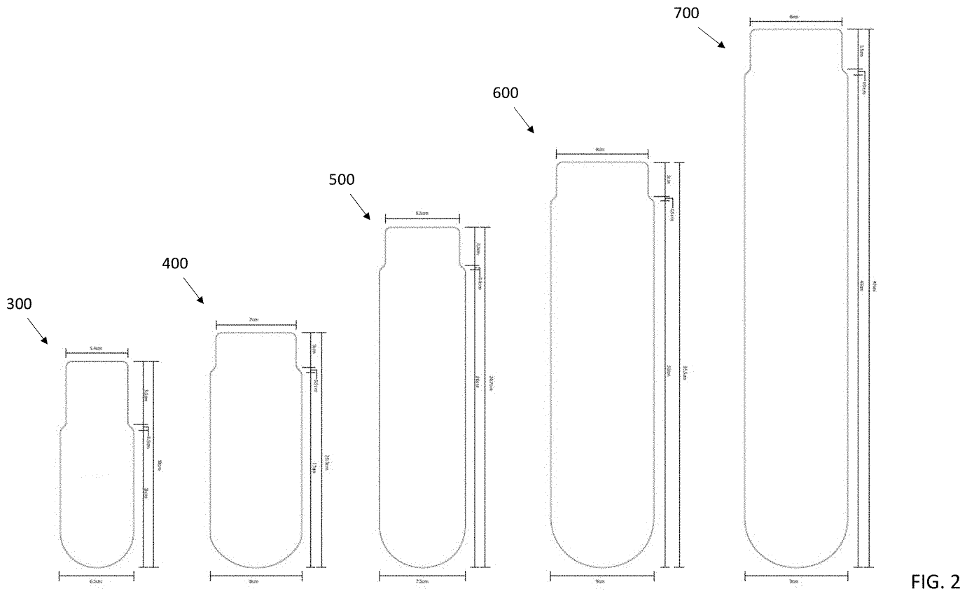

FIG. 1 illustrates socks including jigs (broadly, inserts) therein, which jigs are configured (e.g., shaped with rounded shoulder portions or transitions, etc.) to allow the jigs to be slidably removed from the socks seamlessly without the jigs snagging the socks after sublimating printing on the socks according to exemplary embodiments of the present disclosure. FIGS. 2-7 illustrate the jigs shown in FIG. 1 with exemplary dimensions in centimeters for purpose of illustration only.

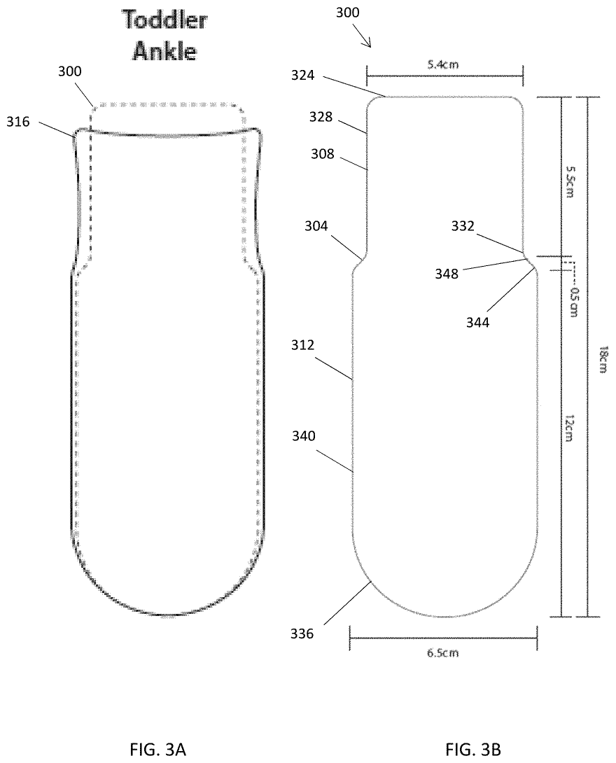

For example, FIG. 3A illustrates an exemplary jig 300 installed within a toddler ankle sock 316. As shown in FIG. 3B, the jig 300 has an overall length of 18 centimeters (cm), a bottom width of 6.5 cm, and a top width of 5.4 cm. The jig's upper portion 308 is narrower than the jig's lower portion 312. The jig's upper portion 308 has a length of 5.5 cm. The jig's lower portion 312 has a length of 12 cm. The jig's rounded shoulder portion or transition 304 between the upper and lower portions 308, 312 has a height or top-to-bottom length of 0.5 cm and left side-to-right side width of 0.55 cm.

With continued reference to FIGS. 3A and 3B, the jig's upper portion 308 is generally rectangular and includes a generally flat linear top 324 and two linear sides 328 generally parallel with each other and generally perpendicular to the flat top 324. Each side 328 depends downwardly from the top 324 to a corresponding one of the top curved portions 332 at the top of the rounded shoulder portions or transitions 304.

The jig's lower portion 312 includes a rounded bottom 336, e.g., to facilitate insertion of the jig 300 into a sock. The lower portion 312 includes two linear sides 340 generally parallel with each other. Each side 340 extends upwardly from the rounded bottom 336 to a corresponding one of the bottom curved portions 344 at the bottom of the rounded shoulder portions or transitions 304.

Each rounded shoulder portion or transition 304 includes a middle portion 348 that extends generally linearly between the outwardly curved portion 332 and the lower inwardly curved portion 344. The middle portions 348 have a length sufficient to accommodate for (e.g., provide a transition for, etc.) the difference in width (e.g., 1.1 cm, etc.) between the jig's narrower upper portion 308 and wider lower portion 312.

Each upper outwardly curved portion 332 at the top of the rounded shoulder portion or transition 304 may be configured such that an obtuse angle is defined generally between the middle portion 348 of the rounded shoulder portion or transition 304 and the corresponding side 328 of the jig's upper portion 308. Each lower inwardly curved portion 344 at the bottom of the rounded shoulder portion or transition 304 may be configured such that an obtuse angle is defined generally between the middle portion 348 of the rounded shoulder portion or transition 304 and the corresponding side 340 of the jig's lower portion 312. The jig 300 may be configured such that the corresponding upper side 308, shoulder portion or transition 304, and lower side 340 cooperatively define a generally S-shaped curve.

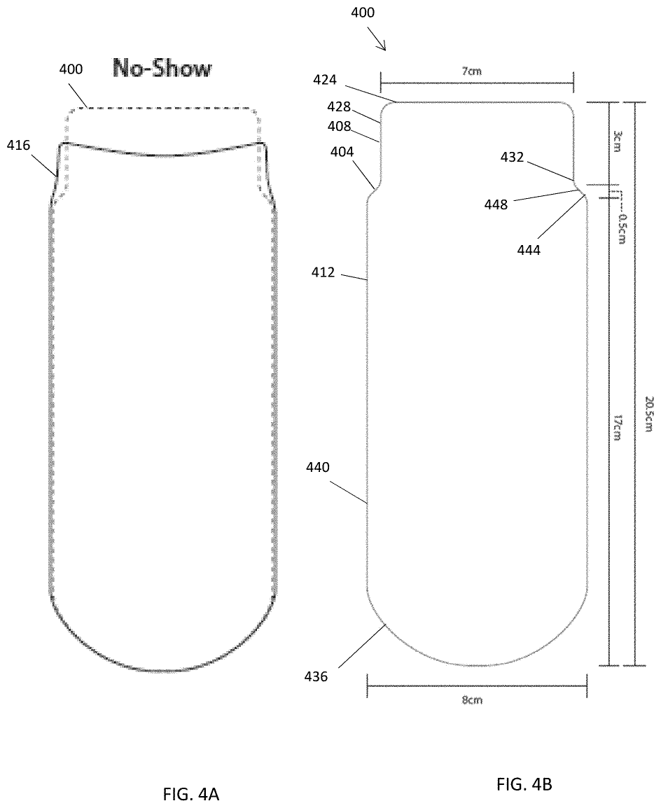

FIG. 4A illustrates an exemplary jig 400 installed within a no-show sock 416. As shown in FIG. 4B, the jig 400 has an overall length of 20.5 centimeters (cm), a bottom width of 8 cm, and a top width of 7 cm. The jig's upper portion 408 is narrower than the jig's lower portion 412. The jig's upper portion 408 has a length of 3 cm. The jig's lower portion 412 has a length of 17 cm. The jig's rounded shoulder portion or transition 404 between the upper and lower portions 508, 512 has a height or top-to-bottom length of 0.5 cm and left side-to-right side width of 0.5 cm.

With continued reference to FIGS. 4A and 4B, the jig's upper portion 408 is generally rectangular and includes a generally flat linear top 424 and two linear sides 428 generally parallel with each other and generally perpendicular to the flat top 424. Each side 428 depends downwardly from the top 424 to a corresponding one of the top curved portions 432 at the top of the rounded shoulder portions or transitions 404.

The jig's lower portion 412 includes a rounded bottom 436, e.g., to facilitate insertion of the jig 400 into a sock. The lower portion 412 includes two linear sides 440 generally parallel with each other. Each side 440 extends upwardly from the rounded bottom 436 to a corresponding one of the bottom curved portions 444 at the bottom of the rounded shoulder portions or transitions 404.

Each rounded shoulder portion or transition 404 includes a middle portion 448 that extends generally linearly between the outwardly curved portion 432 and the lower inwardly curved portion 444. The middle portions 448 have a length sufficient to accommodate for (e.g., provide a transition for, etc.) the difference in width (e.g., 1 cm, etc.) between the jig's narrower upper portion 408 and wider lower portion 412.

Each upper outwardly curved portion 432 at the top of the rounded shoulder portion or transition 404 may be configured such that an obtuse angle is defined generally between the middle portion 448 of the rounded shoulder portion or transition 404 and the corresponding side 428 of the jig's upper portion 408. Each lower inwardly curved portion 444 at the bottom of the rounded shoulder portion or transition 404 may be configured such that an obtuse angle is defined generally between the middle portion 448 of the rounded shoulder portion or transition 404 and the corresponding side 440 of the jig's lower portion 412. The jig 400 may be configured such that the corresponding upper side 408, shoulder portion or transition 404, and lower side 440 cooperatively define a generally S-shaped curve.

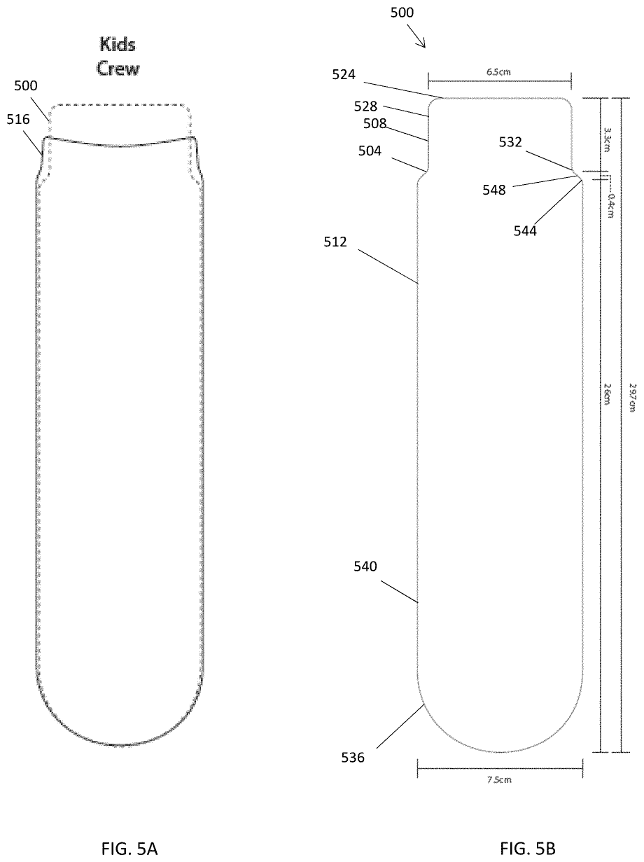

FIG. 5A illustrates an exemplary jig 500 installed within a kids crew sock 516. As shown in FIG. 5B, the jig 500 has an overall length of 29.7 centimeters (cm), a bottom width of 7.5, and a top width of 6.5 cm. The jig's upper portion 508 is narrower than the jig's lower portion 512. The jig's upper portion 508 has a length of 3.3 cm. The jig's lower portion 512 has a length of 26 cm. The jig's rounded shoulder portion or transition 504 between the upper and lower portions 508, 512 has a height or top-to-bottom length of 0.4 cm and left side-to-right side width of 0.5 cm.

With continued reference to FIGS. 5A and 5B, the jig's upper portion 508 is generally rectangular and includes a generally flat linear top 524 and two linear sides 528 generally parallel with each other and generally perpendicular to the flat top 524. Each side 528 depends downwardly from the top 524 to a corresponding one of the top curved portions 532 at the top of the rounded shoulder portions or transitions 504.

The jig's lower portion 512 includes a rounded bottom 536, e.g., to facilitate insertion of the jig 500 into a sock. The lower portion 512 includes two linear sides 540 generally parallel with each other. Each side 540 extends upwardly from the rounded bottom 536 to a corresponding one of the bottom curved portions 544 at the bottom of the rounded shoulder portions or transitions 504.

Each rounded shoulder portion or transition 504 includes a middle portion 548 that extends generally linearly between the outwardly curved portion 532 and the lower inwardly curved portion 544. The middle portions 548 have a length sufficient to accommodate for (e.g., provide a transition for, etc.) the difference in width (e.g., 1 cm, etc.) between the jig's narrower upper portion 508 and wider lower portion 512.

Each upper outwardly curved portion 532 at the top of the rounded shoulder portion or transition 504 may be configured such that an obtuse angle is defined generally between the middle portion 548 of the rounded shoulder portion or transition 504 and the corresponding side 528 of the jig's upper portion 508. Each lower inwardly curved portion 544 at the bottom of the rounded shoulder portion or transition 504 may be configured such that an obtuse angle is defined generally between the middle portion 548 of the rounded shoulder portion or transition 504 and the corresponding side 540 of the jig's lower portion 512. The jig 500 may be configured such that the corresponding upper side 508, shoulder portion or transition 504, and lower side 540 cooperatively define a generally S-shaped curve.

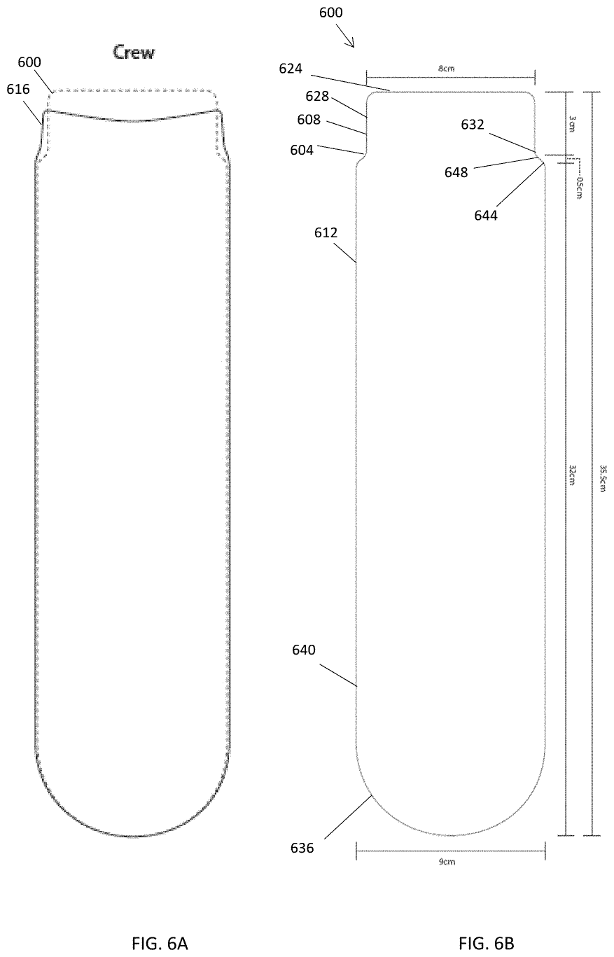

FIG. 6A illustrates an exemplary jig 600 installed within a crew sock 616. As shown in FIG. 6B, the jig 600 has an overall length of 35.5 centimeters (cm), a bottom width of 9 cm, and a top width of 8 cm. The jig's upper portion 608 is narrower than the jig's lower portion 612. The jig's upper portion 608 has a length of 3 cm. The jig's lower portion 612 has a length of 32 cm. The jig's rounded shoulder portion or transition 604 between the upper and lower portions 608, 612 has a height or top-to-bottom length of 0.5 cm and left side-to-right side width of 0.5 cm.

With continued reference to FIGS. 6A and 6B, the jig's upper portion 608 is generally rectangular and includes a generally flat linear top 624 and two linear sides 628 generally parallel with each other and generally perpendicular to the flat top 624. Each side 628 depends downwardly from the top 624 to a corresponding one of the top curved portions 632 at the top of the rounded shoulder portions or transitions 604.

The jig's lower portion 612 includes a rounded bottom 636, e.g., to facilitate insertion of the jig 600 into a sock. The lower portion 612 includes two linear sides 640 generally parallel with each other. Each side 640 extends upwardly from the rounded bottom 636 to a corresponding one of the bottom curved portions 644 at the bottom of the rounded shoulder portions or transitions 604.

Each rounded shoulder portion or transition 604 includes a middle portion 648 that extends generally linearly between the outwardly curved portion 632 and the lower inwardly curved portion 644. The middle portions 648 have a length sufficient to accommodate for (e.g., provide a transition for, etc.) the difference in width (e.g., 1 cm, etc.) between the jig's narrower upper portion 608 and wider lower portion 612.

Each upper outwardly curved portion 632 at the top of the rounded shoulder portion or transition 604 may be configured such that an obtuse angle is defined generally between the middle portion 648 of the rounded shoulder portion or transition 604 and the corresponding side 628 of the jig's upper portion 608. Each lower inwardly curved portion 644 at the bottom of the rounded shoulder portion or transition 604 may be configured such that an obtuse angle is defined generally between the middle portion 648 of the rounded shoulder portion or transition 604 and the corresponding side 640 of the jig's lower portion 612. The jig 600 may be configured such that the corresponding upper side 608, shoulder portion or transition 604, and lower side 640 cooperatively define a generally S-shaped curve.

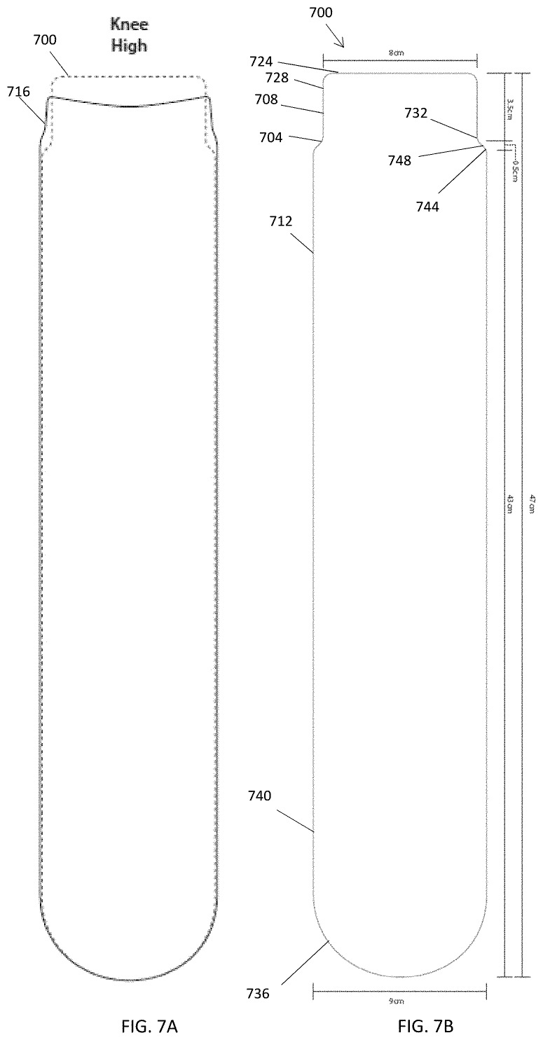

FIG. 7A illustrates an exemplary jig 700 installed within a knee high sock 716. As shown in FIG. 7B, the jig 700 has an overall length of 47 centimeters (cm), a bottom width of 9 cm, and a top width of 8 cm. The jig's upper portion 708 is narrower than the jig's lower portion 712. The jig's upper portion 708 has a length of 3.5 cm. The jig's lower portion 712 has a length of 43 cm. The jig's rounded shoulder portion or transition 704 between the upper and lower portions 708, 712 has a height or top-to-bottom length of 0.5 cm and left side-to-right side width of 0.5 cm.

With continued reference to FIGS. 7A and 7B, the jig's upper portion 708 is generally rectangular and includes a generally flat linear top 724 and two linear sides 728 generally parallel with each other and generally perpendicular to the flat top 724. Each side 728 depends downwardly from the top 724 to a corresponding one of the top curved portions 732 at the top of the rounded shoulder portions or transitions 704.

The jig's lower portion 712 includes a rounded bottom 736, e.g., to facilitate insertion of the jig 700 into a sock. The lower portion 712 includes two linear sides 740 generally parallel with each other. Each side 740 extends upwardly from the rounded bottom 736 to a corresponding one of the bottom curved portions 744 at the bottom of the rounded shoulder portions or transitions 704.

Each rounded shoulder portion or transition 704 includes a middle portion 748 that extends generally linearly between the outwardly curved portion 732 and the lower inwardly curved portion 744. The middle portions 748 have a length sufficient to accommodate for (e.g., provide a transition for, etc.) the difference in width (e.g., 1 cm, etc.) between the jig's narrower upper portion 708 and wider lower portion 712.

Each upper outwardly curved portion 732 at the top of the rounded shoulder portion or transition 704 may be configured such that an obtuse angle is defined generally between the middle portion 748 of the rounded shoulder portion or transition 704 and the corresponding side 728 of the jig's upper portion 708. Each lower inwardly curved portion 744 at the bottom of the rounded shoulder portion or transition 704 may be configured such that an obtuse angle is defined generally between the middle portion 748 of the rounded shoulder portion or transition 704 and the corresponding side 740 of the jig's lower portion 712. The jig 700 may be configured such that the corresponding upper side 708, shoulder portion or transition 704, and lower side 740 cooperatively define a generally S-shaped curve.

Exemplary embodiments are disclosed of systems for sublimation printing on socks while using jigs as disclosed herein. In an exemplary embodiment, a sublimation printing system includes a sublimation heat press with upper and lower heating elements to allow for a single heated press to sublimation print on opposite upper and lower sides, respectively, of the sock. Advantageously, the system may sublimation print on the upper and lower sides of the sock substantially simultaneously without having to flip the sock over for sublimation printing on an opposite side. In contrast, conventional sublimation printing systems include a rotary press with a heated drum that requires the sock to be flipped over to sublimation print on opposite sides.

Also disclosed are exemplary methods relating to sublimation printing a sock, the method includes providing a jig configured to be inserted into a sock to hold a sock cuff in place and/or to maintain the sock in a generally flat shape during sublimation printing and to thereafter be slidably removed from the sock seamlessly without the jig snagging the sock.

In an exemplary embodiment, the method includes preinstalling the jig within a sock, such that the sock is production ready for sublimation printing.

In an exemplary embodiment, the method includes shipping the sock with the jig preinstalled therein in a flat shape.

In an exemplary embodiment, the method includes sublimation printing the sock when the jig is installed within the sock. The sublimation printing may include sublimation printing opposite upper and lower sides of the sock substantially simultaneously without flipping the sock over to sublimation print on the opposite upper and lower sides. Sublimation printing opposite upper and lower sides of the sock substantially simultaneously may include using a sublimation heat press with upper and lower heating elements. The sublimation printing may include sublimation printing on the sock while a thin jig (e.g., thickness less than 2 millimeters (mm), thickness of about 0.4 mm, etc.) is within the sock such that the sublimation printed sock does not include a visible seam defined by the absence of sublimated ink along a side of the sock.

In an exemplary embodiment, the method includes slidably removing the jig from the sublimation printed sock after the sublimation printing. During the sliding removal of the jig from the sublimation printed sock, the jig's rounded shoulder portions or transitions do not snag on the sublimation printed sock. After slidably removing the jig from the sublimation printed sock, the method may include disposing of and not reusing the jig, whereby the jig is a disposable single-use jig.

Although FIGS. 1 and 3-8 show jigs being used with socks having cuffs, the jigs disclosed herein should not be limited to use with only socks having sock cuffs. In alternative exemplary embodiments, the jigs disclosed herein may be used with other types of socks than what is shown in FIGS. 1 and 3-8, e.g., longer or shorter socks, non-white colored socks, socks that do not have a cuff, socks having a separate stitch for the top of the sock instead of a cuff, etc. Accordingly, the jigs disclosed herein should not be limited to use with any particular sock type or only with socks having cuffs.

In an exemplary embodiment, a jig includes an upper portion and a lower portion. A first transition or rounded shoulder portion is along a first side of the jig between the upper portion and the lower portion. A second transition or rounded shoulder portion is along a second side of the jig between the upper portion and the lower portion. The first and second transitions or rounded shoulder portions may be configured to allow the jig to be slidably removed from a sock seamlessly without the jig snagging the sock.

The first transition or rounded shoulder portion, the upper portion, and the lower portion may cooperatively define a first generally S-shaped curve along the first side of the jig. The second transition or rounded shoulder portion, the upper portion, and the lower portion may cooperatively define a second generally S-shaped curve along the second side of the jig.

The first transition or rounded shoulder portion may define a first smooth non-angular transition from the upper portion to the lower portion along the first side of the jig. The second transition or rounded shoulder portion may define a second smooth non-angular transition from the upper portion to the lower portion along the second side of the jig.

The first transition or rounded shoulder portion may define a first curved transition from the upper portion to the lower portion along the first side of the jig, The second transition or rounded shoulder portion may define a second curved transition from the upper portion to the lower portion along the second side of the jig.

The first transition or rounded shoulder portion may include a first top curved portion, a first bottom curved portion, and a first middle portion extending between the first top curved portion and the first bottom curved portion. The second transition or rounded shoulder portion may include a second top curved portion, a second bottom curved portion, and a second middle portion extending between the second top curved portion and the second bottom curved portion.

The upper portion of the jig may be narrower than the lower portion of the jig. The first and second middle portions of the respective first and second transitions or rounded shoulder portions may have lengths sufficient to accommodate for the difference in width between the upper and lower portions of the jig.

The first transition or rounded shoulder portion may be configured such that the first top curved portion provides an inwardly curved or concave transition from the jig's upper portion to the first middle portion and such that the first bottom curved portion provides an outwardly curved or convex transition from the first middle portion to the jig's lower portion. The second transition or rounded shoulder portion may be configured such that the second top curved portion provides an inwardly curved or concave transition from the jig's upper portion to the second middle portion and such that the second bottom curved portion provides an outwardly curved or convex transition from the second middle portion to the jig's lower portion.

The first transition or rounded shoulder portion may be configured such that the first top curved portion defines a first obtuse angle between the jig's upper portion and the first middle portion and such that the first bottom curved portion defines an obtuse angle between the first middle portion and the jig's lower portion. The second transition or rounded shoulder portion may be configured such that the second top curved portion defines a second obtuse angle between the jig's upper portion and the second middle portion and such that the second bottom curved portion defines an obtuse angle between the second middle portion and the jig's lower portion.

The jig's upper portion may be generally rectangular and include a top and two opposite sides depending downwardly from the top to a corresponding one of the first and second top curved portions of the respective first and second transitions or rounded shoulder portions. The jig's lower portion may include a rounded bottom to facilitate insertion of the jig into a sock, and two sides extending upwardly from the rounded bottom to a corresponding one of the first and second bottom curved portions of the respective first and second transitions or rounded shoulder portions.

The jig may be configured to have a length greater than an overall length of the sock such that the upper portion of the jig protrudes outwardly beyond an opening at a top of the sock after the jig is inserted into the sock, to thereby provide an exposed portion of the jig to facilitate grasping and/or slidably pulling the jig from within the sock.

The jig may be configured to have an overall length of 18 centimeters (cm), a bottom width of 6.5 cm, and a top width of 5.4 cm, the upper portion has a length of 5.5 cm, the lower portion has a length of 12 cm, and each of the first and second transitions or rounded shoulder portions has a top-to-bottom length of 0.5 cm and left side-to-right side width of 0.55 cm. Or, the jig may be configured to have an overall length of 20.5 cm, a bottom width of 8 cm, and a top width of 7 cm, the upper portion has a length of 3 cm, the lower portion has a length of 17 cm, and each of the first and second transitions or rounded shoulder portions has a top-to-bottom length of 0.5 cm and left side-to-right side width of 0.5 cm. Or, the jig may be configured to have an overall length of 29.7 cm, a bottom width of 7.5 cm, and a top width of 6.5 cm, the upper portion has a length of 3.3 cm, the lower portion has a length of 26 cm, and each of the first and second transitions or rounded shoulder portions has a top-to-bottom length of 0.4 cm and left side-to-right side width of 0.5 cm. Or, the jig may be configured to have an overall length of 35.5 cm, a bottom width of 9 cm, and a top width of 8 cm, the upper portion has a length of 3 cm, the lower portion has a length of 32 cm, and each of the first and second transitions or rounded shoulder portions has a top-to-bottom length of 0.5 cm and left side-to-right side width of 0.5 cm. Or, the jig may be configured to have an overall length of 47 cm, a bottom width of 9 cm, and a top width of 8 cm, the upper portion has a length of 3.5 cm, the lower portion has a length of 43 cm, and each of the first and second transitions or rounded shoulder portions has a top-to-bottom length of 0.5 cm and left side-to-right side width of 0.5 cm.

The jig may have a thickness less than 2 millimeters. For example, the jig may have a thickness of 0.4 millimeters.

The jig may be configured to be slidably insertable into a sock and slidably removable from a sock seamlessly without the jig snagging the sock.

The jig may be configured to be operable for holding a cuff of a sock in place during sublimation printing on the sock. The jig may be configured to be operable for maintaining a sock in a flat shape.

In an exemplary embodiment, a sublimation printable sock includes the jig within the sublimation printable sock.

In an exemplary embodiment, a system for sublimation printing on a sock includes the jig. The system comprises a sublimation heat press with upper and lower heating elements configured to sublimation print on opposite upper and lower sides, respectively, of the sock including the jig therein. The system is configured to sublimation print on the upper and lower sides of the sock substantially simultaneously without having to flip the sock over for sublimation printing on an opposite side.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “includes,” “including,” “has,” “have,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A jig for use when sublimation printing on a sock, the jig comprising:
an upper portion;
a lower portion;
a first transition along a first side of the jig between the upper portion and the lower portion; and
a second transition along a second side of the jig between the upper portion and the lower portion;
wherein the first and second transitions are configured to allow the jig to be slidably removed from a sock seamlessly without the jig snagging the sock.

2. The jig of claim 1, wherein:
the first transition, the upper portion, and the lower portion cooperatively define a first generally S-shaped curve along the first side of the jig; and
the second transition, the upper portion, and the lower portion cooperatively define a second generally S-shaped curve along the second side of the jig.

3. The jig of claim 1, wherein:
the first transition defines a first smooth non-angular transition from the upper portion to the lower portion along the first side of the jig; and
the second transition defines a second smooth non-angular transition from the upper portion to the lower portion along the second side of the jig.

4. The jig of claim 1, wherein:
the first transition defines a first curved transition from the upper portion to the lower portion along the first side of the jig; and
the second transition defines a second curved transition from the upper portion to the lower portion along the second side of the jig.

5. The jig of claim 1, wherein:
the first transition includes a first top curved portion, a first bottom curved portion, and a first middle portion extending between the first top curved portion and the first bottom curved portion; and
the second transition includes a second top curved portion, a second bottom curved portion, and a second middle portion extending between the second top curved portion and the second bottom curved portion.

6. The jig of claim 5, wherein:
the upper portion is narrower than the lower portion; and
the first and second middle portions of the respective first and second transitions have lengths sufficient to accommodate for the difference in width between the upper and lower portions of the jig.

7. The jig of claim 5, wherein:
the first transition is configured such that the first top curved portion provides an inwardly curved or concave transition from the jig's upper portion to the first middle portion and such that the first bottom curved portion provides an outwardly curved or convex transition from the first middle portion to the jig's lower portion; and
the second transition is configured such that the second top curved portion provides an inwardly curved or concave transition from the jig's upper portion to the second middle portion and such that the second bottom curved portion provides an outwardly curved or convex transition from the second middle portion to the jig's lower portion.

8. The jig of claim 5, wherein:
the first transition is configured such that the first top curved portion defines a first obtuse angle between the jig's upper portion and the first middle portion and such that the first bottom curved portion defines an obtuse angle between the first middle portion and the jig's lower portion; and
the second transition is configured such that the second top curved portion defines a second obtuse angle between the jig's upper portion and the second middle portion and such that the second bottom curved portion defines an obtuse angle between the second middle portion and the jig's lower portion.

9. The jig of claim 5, wherein:
the jig's upper portion is generally rectangular and includes a top and two opposite sides depending downwardly from the top to a corresponding one of the first and second top curved portions of the respective first and second transitions; and
the jig's lower portion includes a rounded bottom to facilitate insertion of the jig into a sock, and two sides extending upwardly from the rounded bottom to a corresponding one of the first and second bottom curved portions of the respective first and second transitions.

10. The jig of claim 1, wherein the jig is configured to have a length greater than an overall length of the sock such that the upper portion of the jig protrudes outwardly beyond an opening at a top of the sock after the jig is inserted into the sock, to thereby provide an exposed portion of the jig to facilitate grasping and/or slidably pulling the jig from within the sock.

11. The jig of claim 1, wherein:
the jig is configured to have an overall length of 18 centimeters (cm), a bottom width of 6.5 cm, and a top width of 5.4 cm, the upper portion has a length of 5.5 cm, the lower portion has a length of 12 cm, and each of the first and second transitions has a top-to-bottom length of 0.5 cm and left side-to-right side width of 0.55 cm; or
the jig is configured to have an overall length of 20.5 cm, a bottom width of 8 cm, and a top width of 7 cm, the upper portion has a length of 3 cm, the lower portion has a length of 17 cm, and each of the first and second transitions has a top-to-bottom length of 0.5 cm and left side-to-right side width of 0.5 cm; or
the jig is configured to have an overall length of 29.7 cm, a bottom width of 7.5 cm, and a top width of 6.5 cm, the upper portion has a length of 3.3 cm, the lower portion has a length of 26 cm, and each of the first and second transitions has a top-to-bottom length of 0.4 cm and left side-to-right side width of 0.5 cm; or
the jig is configured to have an overall length of 35.5 cm, a bottom width of 9 cm, and a top width of 8 cm, the upper portion has a length of 3 cm, the lower portion has a length of 32 cm, and each of the first and second transitions has a top-to-bottom length of 0.5 cm and left side-to-right side width of 0.5 cm; or
the jig is configured to have an overall length of 47 cm, a bottom width of 9 cm, and a top width of 8 cm, the upper portion has a length of 3.5 cm, the lower portion has a length of 43 cm, and each of the first and second transitions has a top-to-bottom length of 0.5 cm and left side-to-right side width of 0.5 cm.

12. The jig of claim 1, wherein the jig has a thickness less than 2 millimeters.

13. The jig of claim 12, wherein the jig has a thickness of about 0.4 millimeters.

14. The jig of claim 1, wherein:
the jig is configured to be slidably insertable into a sock and slidably removable from a sock seamlessly without the jig snagging the sock; and
the jig is configured to be operable for holding a cuff of a sock in place during sublimation printing on the sock; and
the jig is configured to be operable for maintaining a sock in a flat shape.

15. A sublimation printable sock including the jig according to claim 1, wherein the jig is within the sublimation printable sock.

16. A system for sublimation printing on a sock including the jig according to claim 1, the system comprising a sublimation heat press with upper and lower heating elements configured to sublimation print on opposite upper and lower sides, respectively, of the sock including the jig therein, wherein the system is configured to sublimation print on the upper and lower sides of the sock substantially simultaneously without having to flip the sock over for sublimation printing on an opposite side.

17. A jig for use when sublimation printing on a sock, the jig comprising:
an upper portion;
a lower portion;
a first rounded shoulder portion along a first side of the jig between the upper portion and the lower portion; and
a second rounded shoulder portion along a second side of the jig between the upper portion and the lower portion.

18. The jig of claim 17, wherein the first and second rounded shoulder portions are configured to allow the jig to be slidably removed from a sock seamlessly without the jig snagging the sock.

19. The jig of claim 17, wherein:
the first rounded shoulder portion, the upper portion, and the lower portion cooperatively define a first generally S-shaped curve along the first side of the jig; and
the second rounded shoulder portion, the upper portion, and the lower portion cooperatively define a second generally S-shaped curve along the second side of the jig.

20. The jig of claim 17, wherein:
the first rounded shoulder portion defines a first smooth non-angular transition from the upper portion to the lower portion along the first side of the jig; and
the second rounded shoulder portion defines a second smooth non-angular transition from the upper portion to the lower portion along the second side of the jig.

21.-44. (canceled)
